(19) United States
(12) Patent Application Publication
(10) Pub. No.: US 2009/0031257 A1
(43) Pub. Date: Jan. 29, 2009

(54) METHOD AND SYSTEM OF ATTRACTIVE LINKS

(75) Inventors: THEODORE R. ARNESON, IVANHOE, IL (US); William N. Robinson, Sunnyvale, CA (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/828,933

(22) Filed: Jul. 26, 2007

(51) Int. Cl. G06F 3/048

(52) U.S. Cl. 715/862

(57) ABSTRACT

A method (400) or system (200) can include a display (100 or 210) having an object or displayed element (104), a cursor (106) presented on the display manipulated by a user input device (212), and a processor (202) coupled to the display and capable of detecting a position of the cursor. The processor can be programmed to detect (402) a predetermined proximity between the cursor and the displayed element, apply (403) an attraction function to the to the cursor causing the cursor to move towards the displayed element, and apply (404) a delay function reducing further movement of the cursor once the cursor is within another predetermined proximity of the displayed element. The processor can be further programmed to monitor (406) a motion sensor (213) and adjust the attraction function or delay function or both responsive to an output of the motion sensor.

### FIELD

This invention relates generally to user interfaces, and more particularly to cursor control on user interfaces suitable for mobile environments.

### BACKGROUND

Although the concept of attractive links for computing devices is known, the existing techniques fail to optimize the overall user experience based on actual environmental conditions. In one scheme, the attractive link function is used to improve a user's unstable hand input, but fails to take into account the motion the user may be experiencing in their environment. The function is user selectable and no monitoring of the environmental conditions appears to be done. In another technique, an in-car computing device provides cursor control, but without the further refinements that makes for an optimized user experience. In other schemes, forces are applied on a mouse, trackball, or other similar user input devices to provide repelling functions or force feedback to a user operating a user input.

### SUMMARY

Embodiments in accordance with the present invention can provide a method and device that automatically applies an attraction function on a cursor based on a combination of proximity to a display element or hyperlink and further based on motion sensing. Other embodiments can use and enhance the attraction function by introducing time delays to prevent unwanted movement, adjust pull rates toward a link or object, and/or by further monitoring a motion sensor such as an accelerometer to enable, disable, or adjust the attraction function.

In a first embodiment of the present invention, a method of attractive linking to an object such as a hyperlink on a user interface can include the steps of detecting a predetermined proximity of a cursor to an object, applying an attraction function to the cursor causing the cursor to move towards the object (optionally at an increased rate), and applying a delay function reducing further movement of the cursor once the cursor is within another predetermined proximity of the object. The method can further include the step of monitoring a motion sensor and adjusting the attraction function based on a motion sensor reading. The method can further include the step of adjusting the delay and/or attraction functions based on a motion sensor reading. The method can further include monitoring an accelerometer and applying the attraction function to the cursor when the accelerometer detects motion of a predetermined threshold or characteristic. Accordingly, the attraction function to the cursor can be turned off when the accelerometer fails to detect motion of the predetermined threshold or characteristic. The method can further include the step of providing a second cursor that operates as a shadow function of the cursor. In one embodiment, the second cursor can be operated solely through user input.

In a second embodiment of the present invention, a portable electronic device such as cellular phone, a laptop computer, a personal digital assistant, a smart phone or a two-way radio can include a display operable to present a cursor and an object or a displayed element, a cursor control, and a processor coupled to the display and cursor control and capable of detecting a position of the cursor. The processor can be operable to detect a predetermined proximity or a predetermined threshold distance between the cursor and the object or displayed element, apply an attraction function to the to the cursor causing the cursor to move towards the object (optionally at an increased rate), and (in this embodiment) apply a delay function reducing further movement of the cursor once the cursor is within another predetermined proximity or threshold distance of the object or displayed element. The processor can be further programmed to adjust the attraction and/or delay functions based on a motion sensor reading. The motion sensor can be an accelerometer and the processor can be further programmed to monitor the accelerometer and apply the attraction function to the cursor when the accelerometer detects motion of a predetermined threshold or characteristic. The processor can be further programmed to turn off the attraction function to the cursor when the accelerometer fails to detect motion of the predetermined threshold or characteristic. The processor can be further programmed to provide a second cursor that operates as a shadow function of the cursor where the second cursor optionally solely operates though user input.

In a third embodiment of the present invention, a portable electronic device can include a display operable to present a cursor and an object (such as a hyperlink) to a user, a cursor control, a motion sensor for detecting motion of the device, and a processor coupled to the display, the cursor control, and motion sensor. The processor can be operable to detect a predetermined proximity or a predetermined distance threshold between the cursor and the object, apply an attraction function to the cursor causing the cursor to accelerate towards the object when the cursor is within the predetermined threshold distance, and adjust the attraction function for the cursor responsive to an output of the motion sensor. The processor can be further programmed to apply the delay function reducing further movement of the cursor once the cursor is within another predetermined proximity of the object or hyperlink. The portable electronic device can further include an accelerometer as the motion sensor and the processor is further programmed to monitor the accelerometer and apply the attraction function to the cursor when the accelerometer detects motion of a predetermined threshold or characteristic and further programmed to turn off the attraction function to the cursor when the accelerometer fails to detect motion of the predetermined threshold or characteristic. The processor can be further programmed to provide a second cursor that operates as a shadow function of the cursor solely using user input. A “motion sensor” can be any device that detects motion and is not necessarily limited to an accelerometer or a tilt switch. Detecting motion of a predetermined threshold or characteristic can mean detection of a pattern of motion that can be expected in a vehicle and can also simply mean detection of a non-stationary environment.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “proximity” as used herein can be mean within a predetermined border of an object or within a particular distance of an object. An “attraction function” can be a function that causes the cursor to move towards an object at a quicker rate than normal and can also include moving the cursor to the object instantaneously once the cursor reaches a predetermined border or distance from the object. The term “cursor” generally indicates where to place a user input. The term “hyperlink” is a link in a document or some other source to information within that document or the other source. These links are usually represented by highlighted words or images. When a user selects a hyperlink, a display switches to the portion referenced by the hyperlink. The term “displayed element” can be any displayed object including, but not limited to a hyperlink or other objected effected by a user input.

The terms “program,” “software application,” “resizing program” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a display active area with objects or hyperlinks and a cursor in accordance with an embodiment of the present invention.

FIG. 2 is an illustration of the display of FIG. 1 demonstrating the attractive link function in accordance with an embodiment of the present invention.

FIG. 3 is a block diagram of an electronic device in accordance with an embodiment of the present invention.

FIG. 4 is flow chart illustrating a method of attractive linking to an object in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of ways using a variety of technologies that enable precise or assisted positioning of cursors in environments where such precision is difficult to obtain consistently.

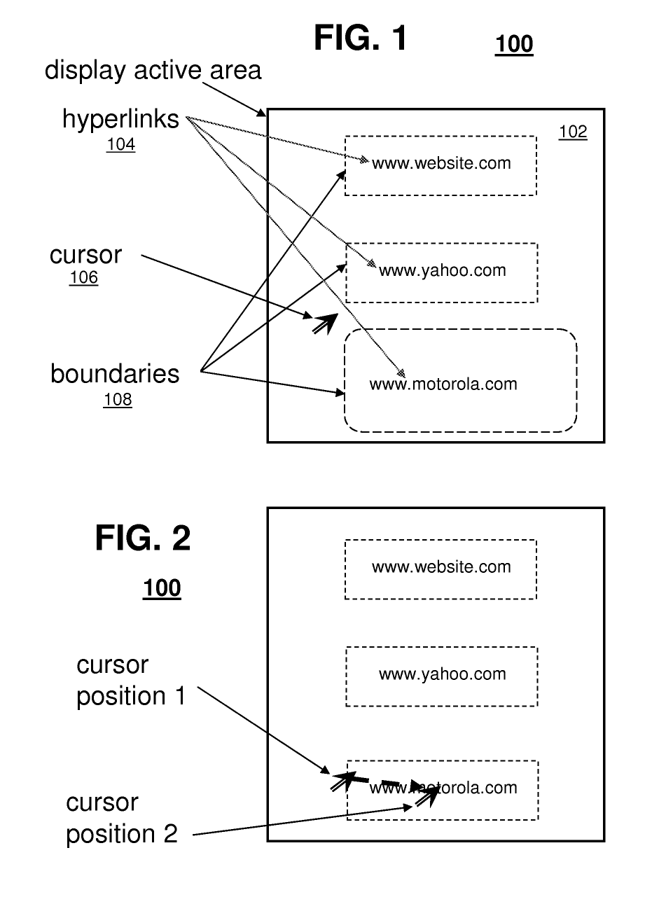

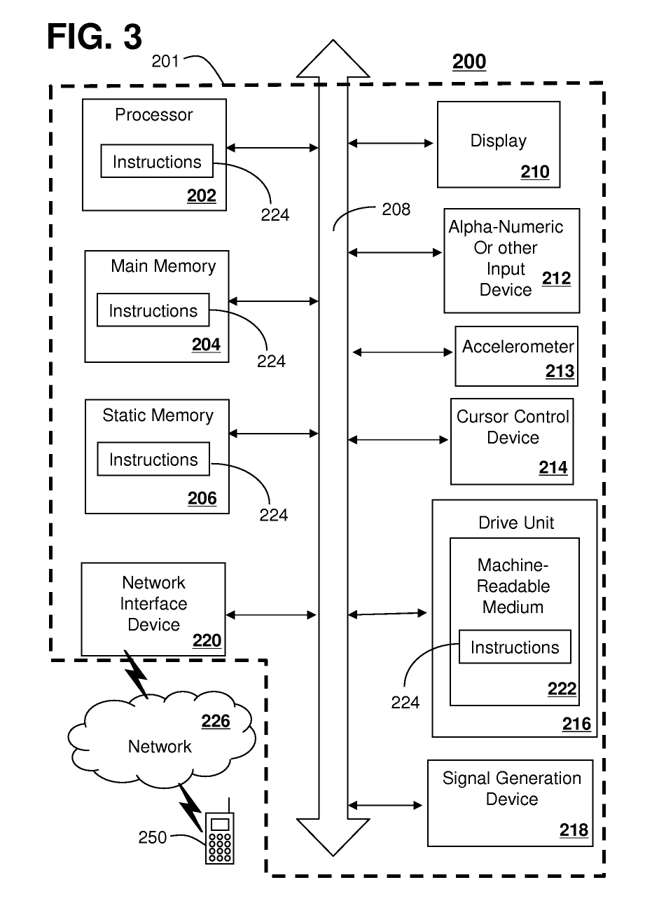

Referring to FIG. 1, a display 100 is shown that can be in any number of portable electronic devices that can have a plurality of objects or hyperlinks 104 within an active area 102 of the display 100. The objects or hyperlinks 104 can each have their respective boundaries 108 or areas of influence that provide a pull effect or attraction function. The boundaries can be set by a user or programmatically. As long as a cursor 106 is outside the boundaries 108, there will be no effect on the cursor 106. Once the cursor is placed within or crosses the boundary as shown in FIG. 2, the cursor 106 will be pulled towards the object or hyperlink 104. The rate at which the cursor 106 is pulled towards the object or link 104 can be adjusted by the user or programmatically based on environmental inputs received at a processor (not shown, but see processor 202 of FIG. 3). The cursor can also be forced to stay or remain on the object or hyperlink for a predetermined time or delay. Again, this delay can be set by the user or adjusted programmatically based on environmental inputs such as inputs from an accelerometer.

In another embodiment of the present invention as illustrated in the diagrammatic representation of FIG. 3, an electronic product such as a machine having a display 210 can include a processor or controller 202 coupled to the display. The electronic product or device can be a hand-held device such as a cellular phone, a personal digital assistant, a smart phone, an MP3 Player, a music player, a remote controller, a laptop computer, and the like. Generally, in various embodiments it can be thought of as a machine in the form of a computer system 200 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication or presentations. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such as the display 210. The computer system 200 may include an input device 212 (e.g., a keyboard, microphone, etc.), a motion detecting device such as an accelerometer 213, a cursor control device 214 (e.g., a mouse or touch pad), a disk drive unit or solid state memory 216, a signal generation device 218 (e.g., a speaker or remote control that can also serve as a presentation device) and a network interface device 220. Of course, in the embodiments disclosed, many of these items are optional.

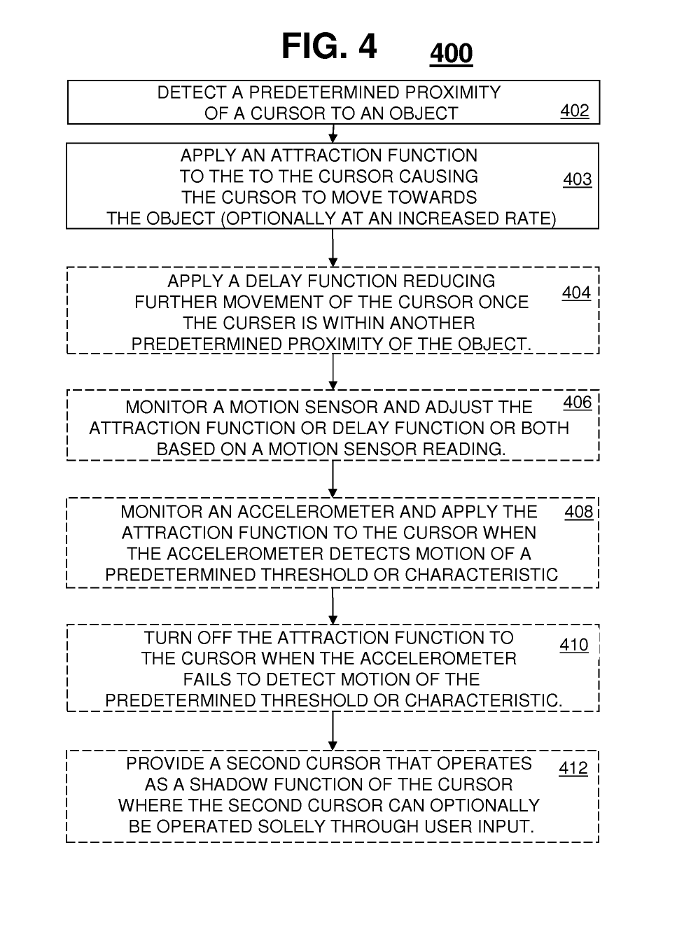

The disk drive unit 216 may include a machine-readable medium 222 on which is stored one or more sets of instructions (e.g., software 224) embodying any one or more of the methodologies or functions described herein, including those methods illustrated previously and with respect to FIG. 4 for example. The instructions 224 may also reside, completely or at least partially, within the main memory 204, the static memory 206, and/or within the processor or controller 202 during execution thereof by the computer system 200. The main memory 204 and the processor or controller 202 also may constitute machine-readable media.

Dedicated hardware implementations including, but not limited to, application specific integrated circuits, programmable logic arrays, FPGAs and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

Referring to FIG. 4, a method 400 of attractive linking to an object such as a hyperlink on a user interface can include the step 402 of detecting a predetermined proximity of a cursor to an object, applying an attraction function to the to the cursor causing the cursor to move towards the object at step 403, and applying a delay function reducing further movement of the cursor once the cursor is within another predetermined proximity of the object at step 404. The method 400 can further include the step 406 of monitoring a motion sensor and adjusting the attraction and/or delay functions based on a motion sensor reading. The method 400 can further include monitoring an accelerometer and applying the attraction function to the cursor when the accelerometer detects motion of a predetermined threshold or characteristic at step 408 and optionally turning off the attraction function to the cursor at step 410 when the accelerometer fails to detect motion of the predetermined threshold or characteristic. For example, when the accelerometer detects sufficient motion such as motion experienced in a moving vehicle or as a pedestrian on the move, then the attraction function will be applied to the cursor and the cursor will move towards an object (optionally at an increased rate). If no such motion is detected or such motion fails to meet a predetermined threshold level (either user programmable or preset), then the attraction function will not be used. The method 400 can further include the step 412 of providing a second cursor that operates as a shadow function of the cursor. In one embodiment, the second cursor can be operated solely through user input. In other words, the shadow function can provide a second cursor that enables the user to manipulate the second cursor solely though user input while the first cursor remains under the influence of the attraction or delay function imposed by a processor.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of attractive linking to an object on a user interface, comprising the steps of:
detecting a predetermined proximity of a cursor to an object;
applying an attraction function to the cursor causing the cursor to move towards the object; and
applying a delay function reducing further movement of the cursor once the cursor is within another predetermined proximity of the object.

2. The method of claim 1, wherein the method further comprises the step of monitoring a motion sensor and adjusting the attraction function based on a motion sensor reading.

3. The method of claim 1, wherein the method further comprises the step of monitoring a motion sensor and adjusting the delay function based on a motion sensor reading.

4. The method of claim 2, wherein the method further comprises the step of adjusting the delay function based on the motion sensor reading.

5. The method of claim 1, wherein the method further comprises the step of monitoring an accelerometer and applying the attraction function to the cursor when the accelerometer detects motion of a predetermined threshold or characteristic.

6. The method of claim 5, wherein the method further comprises the step of turning off the attraction function to the cursor when the accelerometer fails to detect motion of the predetermined threshold or characteristic.

7. The method of claim 1, wherein the method further comprises the step of providing a second cursor that operates as a shadow function of the cursor.

8. The method of claim 7, wherein the method further comprises the step of operating the second cursor solely through user input.

9. The method of claim 1, wherein the object is a hyperlink.

10. A portable electronic device, comprising:
a display operable to present a cursor and an object to a user;
a cursor control; and
a processor coupled to the display and cursor control and capable of detecting a position of the cursor, wherein the processor is operable to:
detect a predetermined threshold distance between the cursor and the object;
apply an attraction function to the to the cursor causing the cursor to move towards the object; and
apply a delay function reducing further movement of the cursor once the cursor is within another predetermined threshold distance of the object.

11. The portable electronic device of claim 10, wherein the processor is further programmed to monitor a motion sensor and adjust the attraction function or delay function or both based on a motion sensor reading.

12. The portable electronic device of claim 10, wherein the portable electronic device further comprises an accelerometer and the processor is further programmed to monitor the accelerometer and apply the attraction function to the cursor when the accelerometer detects motion of a predetermined threshold or characteristic.

13. The portable electronic device of claim 12, wherein the processor is further programmed to turn off the attraction function to the cursor when the accelerometer fails to detect motion of the predetermined threshold or characteristic.

14. The portable electronic device of claim 10, wherein the processor is further programmed to provide a second cursor that operates as a shadow function of the cursor.

15. The portable electronic device of claim 14, wherein the processor is further programmed to operate the second cursor solely through user input.

16. The portable electronic device of claim 10, wherein the portable electronic device is a cellular phone, a laptop computer, a personal digital assistant, a smart phone or a two-way radio.

17. A portable electronic device, comprising:
a display operable to present a cursor and an object to a user;
a cursor control;
a motion sensor for detecting motion of the device; and
a processor coupled to the display, the cursor control and the motion sensor, the processor operable to:
detect a predetermined threshold distance between the cursor and the object;
apply an attraction function to the cursor causing the cursor to accelerate towards the object when the cursor is within the predetermined threshold distance; and
adjust the attraction function for the cursor responsive to an output of the motion sensor.

18. The portable electronic device of claim 17, wherein the object is a hyperlink and wherein the processor is further programmed to apply a delay function reducing further movement of the cursor once the cursor is within another predetermined proximity of the hyperlink.

19. The portable electronic device of claim 17, wherein the portable electronic device further comprises an accelerometer as the motion sensor and the processor is further programmed to monitor the accelerometer and apply the attraction function to the cursor when the accelerometer detects motion of a predetermined threshold or characteristic and further programmed to turn off the attraction function to the cursor when the accelerometer fails to detect motion of the predetermined threshold or characteristic.

20. The portable electronic device of claim 17, wherein the processor is further programmed to provide a second cursor that operates as a shadow function of the cursor solely using user input.
